(19) United States
(12) Patent Application Publication
(10) Pub. No.: US 2003/0122363 A1
(43) Pub. Date: Jul. 3, 2003

(54) Operating method and system for vehicle safety device

(76) Inventor: Olaf Muller, Russelsheim (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/299,087

(22) Filed: Nov. 18, 2002

Related U.S. Application Data
(63) Continuation-in-part of application No. 09/845,218, filed on Apr. 30, 2001, now abandoned.
Application No. 09/845,218 is a continuation of application No. 09/227,820, filed on Jan. 11, 1999, now abandoned.

(51) Int. Cl. B60R 22/36; B60R 22/46

(52) U.S. Cl. 280/806

(57) ABSTRACT

An operating system and method for a vehicle safety device that includes a housing having a duct, one or more pistons in the duct and a gas generator that has two stages. The first stage is ignited conventionally, but the second stage is ignited automatically with a delay directly responsive to the first stage ignition. The gas generated is fed to a common space in the housing where it drives the piston(s). Each piston has an associated axially spaced thimble with a load limiter between. A cable is connected to each vehicle safety device and to each thimble. When the system is operated, each piston is driven to move its associated thimble away to draw the cable from the associated vehicle safety device to actuate it. However, if a counter force on the cable becomes excessive, the thimble moves closer to the piston and the excessive pressure is relieved under the control of the load limiter.

### RELATED APPLICATION

This application is a continuation-in-part of application Ser. No. 09/845,218 filed Apr. 30, 2001, which is a continuation of application Ser. No. 09/227,820 filed Jan. 11, 1999

BACKGROUND OF THE INVENTION

1. Field of the Invention

The present invention relates to a novel operating method and system for vehicle safety devices.

2. Prior Art

Such operating systems are, for example, used with seat belt tightening devices. A typical seat belt-tightening device of this type will contain a guide housing, at least one driving element, piston, which is accommodated therein, and which is coupled by a cable to at least one safety device. Gas pressure is generated in the housing to drive the piston to operate the tensioning or tightening of the safety device. The gas pressure is generated from a pyrotechnic material contained in a canister with a triggering device, so that the material is ignited in response to a crash of the vehicle. The piston is driven in its cylinder a sufficient distance to pull the cable connected to the safety device to apply sufficient tension or tightening so the safety device can perform its proper function.

Such operating devices can, for example, be used with seat belts, as adjusting devices for seat adjustments, steering wheel adjustments and other mechanically operated safety devices. A disadvantage of such operating devices, as presently known and used, is that, in the event of an accident, after triggering, the gas pressure rises rapidly and, after a peak value is reached, also falls rapidly. As a result, a high gas pressure for acting upon the driving element is available only for a short time. However, the safety devices, on the one hand, require the driving element to move a preselected distance and operate as fast as possible, but on the other hand, there should be a limit on the maximally permissible moving or operating path of the driving element, depending on the safety device, to prevent the safety device itself from causing injury to the passenger or driver sought to secured. Accordingly, the prior devices tended to use too large an amount of gas and made it available too rapidly. As noted, this has the danger that the peak value of the used gas pressure can lead to injuries of the occupants of a vehicle by the safety devices themselves in the event of an accident. The course of the pressure made available by the gas pressure generating devices used so far has been unsatisfactory in the respects described.

### SUMMARY OF THE INVENTION

It is, therefore, an object of the present invention to provide a novel operating system and a novel operating method for vehicle safety devices, which will have an improved performance. According to the invention, this is achieved by a system comprising a housing providing a plurality of ducts or channels in which are located one gas generating device of unique design and at least one or more driving elements. The unique gas generator will generate gas that does not reach too high a pressure level while maintaining a sufficient level of pressure for a sufficient time. Each of the driving elements or pistons is connected, in turn, by a cable to a vehicle safety device. Each driving element or piston is provided with a load limiter to prevent excessive pressure or tension from being imposed on the vehicle occupant.

An operating system and method for a vehicle safety device that includes a housing having a duct, one or more pistons in the duct and a gas generator that has two stages. The first stage is ignited conventionally, but the second stage is ignited automatically with a delay directly responsive to the first stage ignition. The gas generated is fed to a common space in the housing where it drives the piston(s). Each piston has an associated axially spaced thimble with a load limiter between. A cable is connected to each vehicle safety device and to each thimble. When the system is operated, each piston is driven to move its associated thimble away to draw the cable from the associated vehicle safety device to actuate it. However, if a counter force on the cable becomes excessive, the thimble moves closer to the piston and the excessive pressure is relieved under the control of the load limiter.

The system, according to the invention, provides gas pressure generating devices containing at least two successively driving stages and a triggering control by which generation of the gas pressure takes place initially in the first stage by conventional triggering, and responsive to triggering of the first stage, after a predetermined delay, the generation automatically takes place in the second stage so that overall the gas generation of the two stages takes place in a partially superimposed manner without ever exceeding a predetermined pressure value.

As a result, a gas pressure course is achieved that provides a longer lasting maximum. This makes sufficient gas pressure available for satisfactorily moving the driving element without an excessive gas pressure peak. The invention advantageously also permits the driving elements, such as pistons, to move faster and have a stronger pull. Finally, the elimination of en excessive gas pressure peak leads to avoiding a risk of injury to the occupants by the safety devices themselves.

Preferably, the triggering control contains mechanical, chemical, electric and/or electronic retarding and triggering devices which can be triggered by one driving stage triggering the correspondingly following driving stage. One arrangement is for chemical retarding and triggering devices connected behind mechanical retarding and, triggering devices.

The mechanical retarding and triggering devices preferably contain an ignition triggering mechanism, which can be operated by a triggered driving stage, and an igniter for the driving stage which follows the triggered driving stage. The predetermined delay between the triggerings of two successive driving stages can be determined by the duration of the course of the ignition triggering mechanism and the ignition performance of the igniter. It is particularly preferred for the ignition triggering mechanism to contain an ignition piston and a valve, and for the ignition piston, by way of the driving stage, which operates the ignition triggering mechanism for triggering the igniter of the driving stage which follows, to be movable toward this igniter. This last embodiment can be further developed by having the mechanical retarding and triggering devices contain a valve which control the gas flows between two successive driving stages by having it closed until triggering of the driving stage which follows by a triggered driving stage and subsequently opened up in order to ensure an operation of the ignition piston in the closed condition and gas flow from the driving stage which follows into the pressure receiving space in the open condition. In this case, the valve is preferably provided in the ignition piston.

According to a further aspect of the invention, the mechanical retarding and triggering devices can contain an ignition triggering mechanism operated by a triggered driving stage. A delay between the triggerings of two successive driving stages can be determined by the duration of the sequence of the ignition triggering mechanism. The ignition triggering mechanism, can also contain a pressure collection space which can be filled with pressure gas by a triggered driving stage and which separates the triggered driving stage from the driving stage which is to be triggered subsequently. A threshold device, such as a bursting disk or similarly acting valve can be provided as well. Such a threshold device closes off the pressure collection space toward the driving stage which is to be triggered subsequently and opens it up at a defined pressure in the pressure collection space in order to cause ignition of the driving stage, which is to be triggered subsequently, with the pressure gas from the triggered driving stage. Such a bursting plate or disk may include weakenings or weak points for determining the gas pressure in the pressure collection space at which the bursting plate bursts. In addition, a free zone or soft zone can be provided between the bursting plate and the driving stage to be triggered in order to provide a sufficient path for the bursting of the bursting plate.

According to another feature of the operating system, according to the invention, the first driving stage of the gas pressure generating devices can be electrically or electronically triggerable.

In order to meet the inventive requirements in the event of accidents, the triggering control for triggering a driving stage is preferably approximately 1 ms to approximately 5 ms, and preferably approximately 2 ms, after the triggering of a preceding driving stage.

The driving element may be a piston of either a belt tightening device or an adjusting device.

The invention can be used particularly advantageously when a plurality of driving elements (pistons) are arranged in cylinders formed in a guide housing and are acted upon by gas pressure generated from a single multi-stage gas generating device, which feeds the gas into a common pressure receiving space to which all pistons are exposed. This enables a space- and cost-saving arrangement. The guide housing preferably has an extruded profile which optionally contains a multiplicity of guide paths. Constructing the gas pressure generating devices as a cartridge and/or are housed in the guide housing is also particularly efficient.

Since the pressure receiving space is enlarges because of movement of the driving element, it is preferred that the second stage of the gas generating device generate a larger amount of gas than the first or preceding stage.

According to a further aspect of the invention, a load limiting device is provided in order to ensure a predetermined yielding performance of the safety device, to which the operating system is coupled. In the arrangement, the cable connected to the safety device is connected to an element of the load limiter, which in turn, functions with the piston to relieve any excessive counterforce imposed on an occupant due to the safety device. This can occur even when the piston is blocked with respect to a return motion. Such a load limiting device may be provided, for example, between a piston and a thimble for coupling the driving element (piston) via a cable to a safety device. In another forms, the load limiting device may operate by material deformation, by material cutting, and/or hydraulically.

The guide housing according to the invention preferably may form a stiffening part of a vehicle structure, and particularly a cross traverse.

In the operating method according to the invention, for safety devices in a vehicle, a gas pressure is generated by gas pressure generating devices in a pressure receiving space. The gas pressure acts upon at least one driving element along an operating path, which driving element is coupled to at least one safety device for its operation. The gas pressure in the pressure receiving space is generated by at least two successive and partially superimposed gas pressure surges of individual driving stages of the gas pressure generating devices.

A preferred development of the invention is that mechanical, chemical, electric and/or electronic retarding and triggering devices for a second or subsequent gas generation driving stage are activated automatically with a predetermined delay upon triggering of a first gas generating driving stage.

Still further objects and advantages are obtained from an operating system for a vehicle safety device according to the invention can comprise in combination; a housing defining at least one elongated duct and a common space in said duct, a driving element having a working face received in the at least one duct for reciprocal sliding movement with its working face exposed to said common space, a gas generating member comprised of an elongated cartridge mounted in the housing with one end of the cartridge exposed to communicate with the common space of the housing, said cartridge containing at least a first gas generating stage and a second gas generating stage, each stage containing pyrotechnic material capable of generating gas when ignited, arranged coaxially aligned and axially positioned one behind the other with the first gas generating stage adjacent the one end of the cartridge exposed to communicate with the common space of the housing, the cartridge wall being thinned in the location of the first gas generating stage such that upon ignition of the first gas generating stage generated gas bursts through the thinned wall into the common space of the housing, a first triggering member incorporated in the first gas generating stage that is triggered responsive to a vehicle experiencing a crash of a predetermined degree, and a second triggering member associated with the first and second gas generating stages that is triggered, with a predetermined delay, automatically by the gas generation of the first gas generating stage to generate in the second gas generating stage gas that flows out through the first stage and into the common space of the housing, a thimble member mounted in the at least one elongated duct for sliding movement and axially spaced from the driving member, a vehicle safety device, a cable connected at one end to actuate the vehicle safety device, extending into the at least one duct, bypassing the driving element and connected at its other end to the thimble member, and a load limiting member associated with the driving element and thimble to relieve an excess force imposed on the cable greater than the gas pressure imposed on the face of the driving element.

The operating system for a vehicle safety device according to the invention can apply to a vehicle safety device that may be one of a seat belt tensioning device, a buckle tightening device, an automatic belt tightening device, a belt end fitting device, a seat ramp mover device, a knee padding device, a brake pedal device, a cargo locking device and a steering system position changing device.

The operating system for a vehicle safety device according to the invention may be arranged wherein the housing has two driving elements received in said at least one elongated duct with the working faces of the driving elements arranged in opposition and both exposed to the common space, a thimble member and a load limiter associated with each driving element.

In the operating system for a vehicle safety device according to the invention each load limiter may be comprised of a corrugated tube engaged at one end with its associated thimble and at the other end with its associated driving element. The load limiter can include a corrugated tube attached at one end to the thimble and at its other end to the driving element. Also, the load limiter can contain a hydraulic fluid, and the load limiter include an exhaust opening through with the hydraulic fluid can escape during deformation of the corrugated tube. Also, the exhaust opening can be in the form of a nozzle. A needle valve can be operatively connected to the driving element and adapted to control the exhaust opening of the nozzle.

The operating system for a vehicle safety device according to the invention can be arranged wherein the second triggering member includes an ignition pin and an igniter that are spaced axially with the ignition pin being driven into the igniter responsive to gas generated in the first gas generation stage. Further, the second triggering member can include two ignition pins and two igniters.

The operating system for a vehicle safety device according to the invention can be arranged wherein the load limiter is comprised of a cutting blade positioned adjacent the rear of the driving element axially opposite its working face such that in repose the cutting blade lies adjacent the inner surface of the duct, and responsive to the thimble being drawn toward the driving element due to a greater counterforce, the thimble contacts the cutting blade and rocks it toward the inner wall of the duct forcing it to dig in a predetermined depth into the inner wall of the duct so that further movement of the thimble in the direction of the driving element causes a sliver to be peel from the inner surface of the duct while relieving any excessive counterforce.

The operating system for a vehicle safety device according to the invention can be arranged wherein the gas generating member is carried by the driving member. Also, the gas generating member can be positioned in a duct in the housing.

The operating system for a vehicle safety device according to the invention can be arranged wherein the housing defines a plurality of ducts with a driving element positioned in each duct.

The operating system for a vehicle safety device according to the invention can be arranged wherein the housing is composed of two parts detachably connected together, and the gas generating member is located in the housing in proximity to the detachable connection to enable easy replacement. Also, the operating system for a vehicle safety device according to the invention can be arranged wherein the housing is composed of two telescoping parts, and a load limiter is connected between the two telescoping parts.

Further, the operating system for a vehicle safety device according to the invention can be arranged wherein the gas generating member is mounted in the housing and projects out of the housing. Also, the housing can be incorporated as part of a vehicle cross seat traverse. Still further, the operating system for a vehicle safety device according to the invention can be arranged wherein the load limiter is programmable. Also, the operating system for a vehicle safety device according to the invention can be arranged wherein the second stage of the gas generating member generates a greater volume of gas than the first stage.

The method for controlling a vehicle safety device according to the invention can comprise the steps of

(a) providing a housing defining at least one elongated duct and a common space in said duct with a driving element having a working face received in the at least one duct for reciprocal sliding movement with its working face exposed to said common space, a thimble member mounted in the at least one elongated duct for sliding movement and axially spaced from the driving member, a cable connected at one end to actuate the vehicle safety device, extending into the at least one duct, bypassing the driving element and connected at its other end to the thimble member, and a load limiting member associated with the driving element and thimble to relieve an excess force imposed on the cable greater than the gas pressure imposed on the face of the driving element,

(b) responsive to a crash of a predetermined severity, igniting in a first stage a pyrotechnic material and generating a gas pressure in the common space of the housing to force the driving element to slide in the duct in a direction to push the thimble via the load limiter to draw the cable away from the vehicle safety device to actuate the vehicle safety device,

(c) responsive to the ignition of the first stage and with a predetermined delay automatically igniting in a second stage a pyrotechnic material to generate a further gas pressure that flows through the first stage and into the common space to maintain the pressure level in the common space at a maximal level to continue to force the driving element to continue its slide in the duct for a longer period of travel, and

(d) responsive to an excessive counter force imposed on the cable by the vehicle safety device greater than being imposed on the driving element by the gas pressure to actuate the load limiter to move the thimble closer to the driving element to relieve the excessive counter force.

The method of the invention can be arranged so that the gas generated in the second stage has a greater volume than the gas generated in the first stage.

Other and further objects and advantages of the invention will become apparent from the following.

### BRIEF DESCRIPTION OF THE DRAWINGS

The invention will be described in detail in the following with reference to the drawings.

FIG. 1 is a graph of a gas pressure course of a gas generating device of the operating system for vehicle safety devices according to the invention;

FIGS. 2a, 2b and 2c are schematic sectional views of successive conditions of a gas generating device of the operating system for vehicle safety devices according to the invention;

FIG. 3 is a schematic sectional view of another version of the gas generating device as shown in FIGS. 2a, 2b and 2c;

FIG. 4 is a schematic sectional view of a subassembly of an operating system for vehicle safety devices according to the invention showing two driving pistons being driven from gas generated from a single two-stage canister;

FIG. 5 is a schematic sectional view of a version of an operating system for vehicle safety devices according to the invention showing a single housing containing four driving pistons and containing only a single two-stage gas generating device;

FIGS. 6a, 6b, 6c and 6d are four sectional views of the operating system shown in FIG. 5;

FIG. 7 is a schematic sectional view of a still another version of a gas generating device as used in the operating system for vehicle safety devices according to the invention;

FIG. 8 is a schematic sectional view of an operating system for safety devices in a vehicle according to the invention showing an assembly that includes a load limiter;

FIG. 9 is a schematic two-part sectional view of an operating system for safety devices in a vehicle according to the invention showing two pistons and load limiters for each;

FIGS. 10a and 10b are schematic sectional views of an operating system for safety devices in a vehicle according to the invention showing the gas generating devices carried by the one cylinder of two pistons that are spaced apart due to narrow mounting spaces;

FIG. 11 is a schematic partial sectional view of an operating system for safety devices in a vehicle according to the invention illustrating load limiters cooperating with two pistons, with the load limiters being at different levels;

FIG. 12 is a schematic two-part sectional view of an operating system for safety devices in a vehicle according to the invention illustrating the use of hydraulic fluid and an escape nozzle for acting as the load limiter;

FIG. 13 is a schematic two-part sectional view of an operating system for safety devices in a vehicle according to the invention illustrating how the system can be incorporated into the vehicle structure to add to vehicle stiffness;

FIG. 14 is a schematic partial sectional view of a portion of an operating system for vehicle safety devices according to the invention showing a novel load limiting arrangement; and

FIG. 15 is a schematic partial sectional view of a portion of an operating system for vehicle safety devices according to the invention showing another novel load limiting arrangement.

### DETAILED DESCRIPTION OF THE PREFERRED EMBODIMENTS

In the drawings, identical and similar parts or identically and similarly acting parts have been given the same reference numbers. Also, a description of parts and characteristics that are discussed in connection with one aspect of the invention is omitted in order to avoid repetition in the description of other aspects which follow.

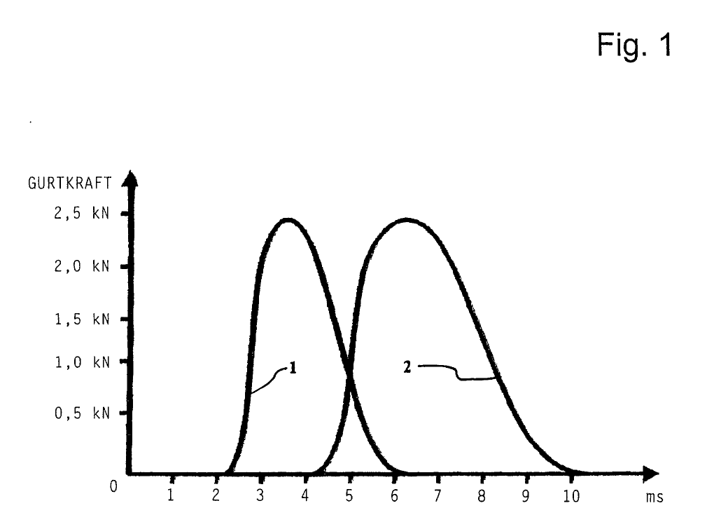

The novel operating system for vehicle safety devices of the present invention consists of several components that will be described in detail hereinafter. The system consists of a vehicle containing a safety device, a guide housing containing one or more driving elements consisting of pistons in ducts or cylinders, and one multi-stage gas generating device that is contained in an elongated canister. The housing provides a common space where the gas generated from the gas generating device feeds into when ignited, and all the pistons are exposed to the common space to be driven by the gas pressure generated. The gas generating device is usually two-stage with the two stages coaxially spaced and aligned end to end. The gas is generated stage by stage with the second stage being automatically ignited by ignition of the first stage, but with a 2 ms delay. The generated gas is fed into the common space and has the characteristic of the graph of FIG. 1, as will be explained in more detail hereinafter. A cable, for example a Bowden cable, is connected to each driving element via a load limiter to prevent excessive counter-forces on the occupant protected by the safety device. The various components of the invention will be described in greater detail in the following description taken in conjunction with the drawings.

Referring first to FIGS. 1-4, the gas generating component will be described in detail. This gas generating component is part of the assembly of the system of the invention as noted above. FIG. 1 is a schematic illustration of the pressure course of the novel two-stage gas pressure generating devices that form a component of the novel operating system. Curve 1 shows the gas pressure course of a first driving stage of the two-stage gas pressure generating devices and curve 2 illustrates the gas pressure course of a second driving stage of the devices. The force which is concretely illustrated is that which is exercised on a seat belt which has a belt tightening device as an operating system according to the invention. The force is shown in kN along the time-related course of the triggerings of the two driving stages.

The first driving stage is triggered in known fashion approximately 5 ms after an event, such as an accident. After another approximately 2 ms, that is, approximately 7 ms after the triggering event, the second driving stage is automatically triggered. However, at this time, the gas pressure from the first driving stage has not yet completely diminished or gone back to zero (see curve 1). The gas pressure of the second driving stage (see curve 2) of the gas pressure generating devices, which is already rising at this moment, is superimposed on the still existing remainder of the gas pressure of the first driving stage of the gas pressure generating devices, so that the sum of both pressures is available and thus a predetermined pressure level is obtained. The operating system according to the invention makes a maximal gas pressure for driving a driving element available for a longer period of time than if only a single driving stage is used.

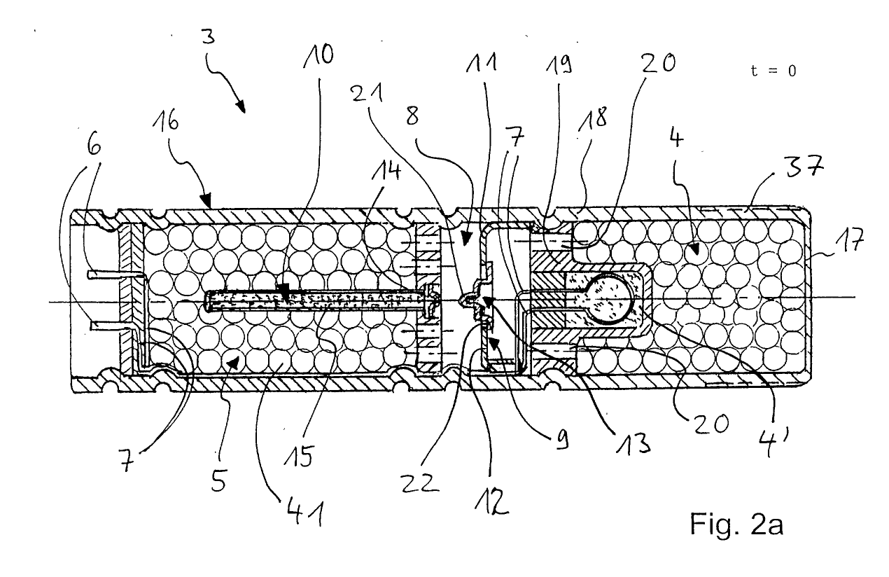

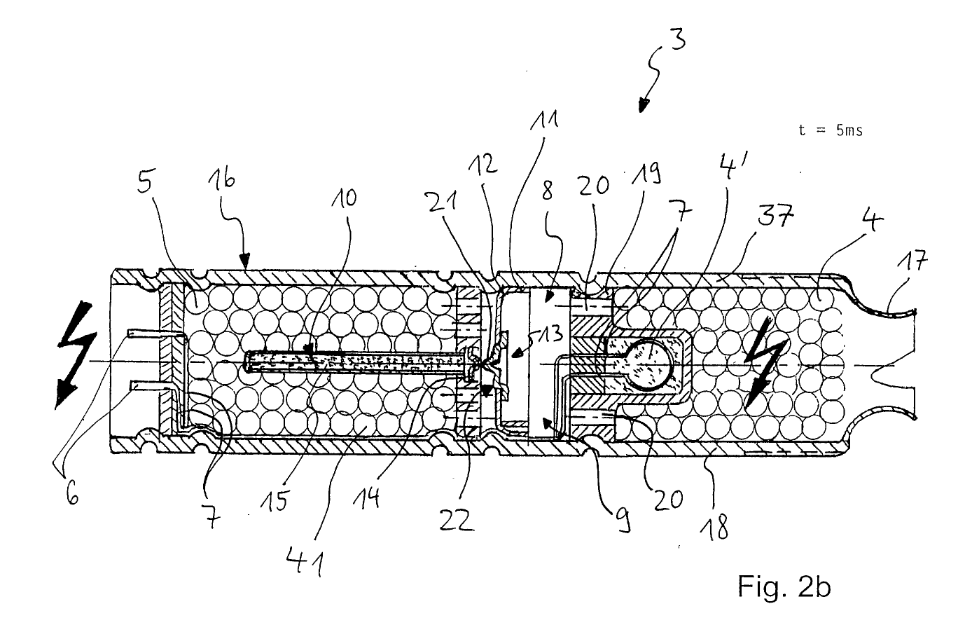

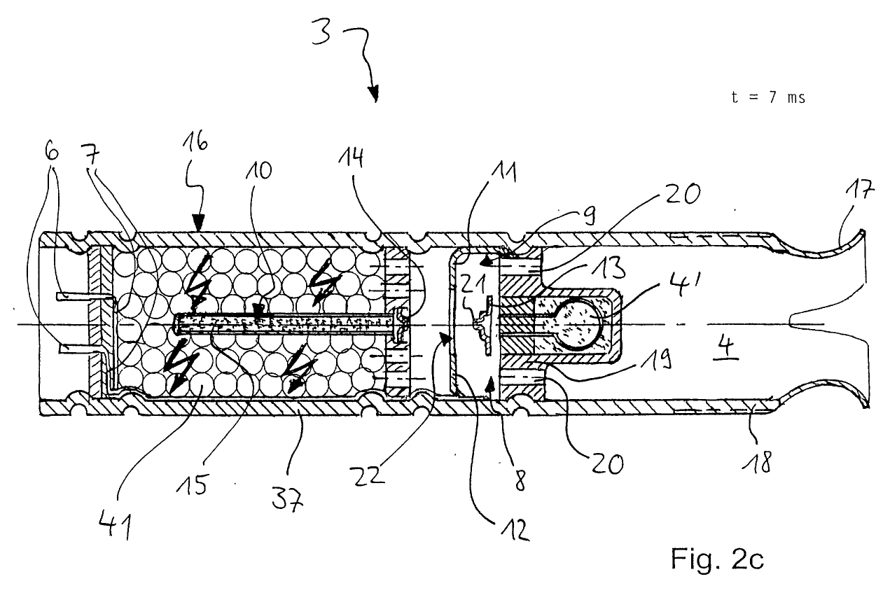

One version of a two-stage gas generating device, a component of the inventive system, can be implemented, for example, as shown schematically in the sectional views in FIGS. 2a, 2b and 2c. FIGS. 2a, 2b and 2c illustrate conditions of gas pressure generating devices 3 at different times, specifically at a time t=0 ms (FIG. 2a), t=5 ms (FIG. 2b) and t=7 ms (FIG. 2c) after an event which results in initially triggering the first stage of the device. The gas pressure generating devices 3 contain a first pyrotechnic driving stage 4 and a second pyrotechnic driving stage 5 which are coaxially mounted in a canister, axially spaced with an intervening axially space.

FIG. 2a shows both the first driving stage 4 and the second driving stage 5 of the gas pressure generating devices 3 as untriggered. The first driving stage 4 can be electrically triggered by electric contacts 6 and lines 7 by way of an electric igniter 4, as is known. The second driving stage 5 is triggered automatically, that is in response to the triggering of stage one, by way of a novel triggering control 8. The triggering control 8 contains mechanical as well as chemical retarding and triggering devices 9 and 10.

The mechanical retarding and triggering devices 9 contain an ignition triggering mechanism 11 which contains an ignition piston 12 and a valve 13, as well as, an igniter 14 for the second driving stage 5. In the second driving stage 5, chemical retarding and triggering devices 10 are also provided, which contain a chemical ignition retarder 15. The first driving stage 4 and the second driving stage 5 as well as the triggering control 8 are housed as a cartridge or canister in a common cylindrical housing 16.

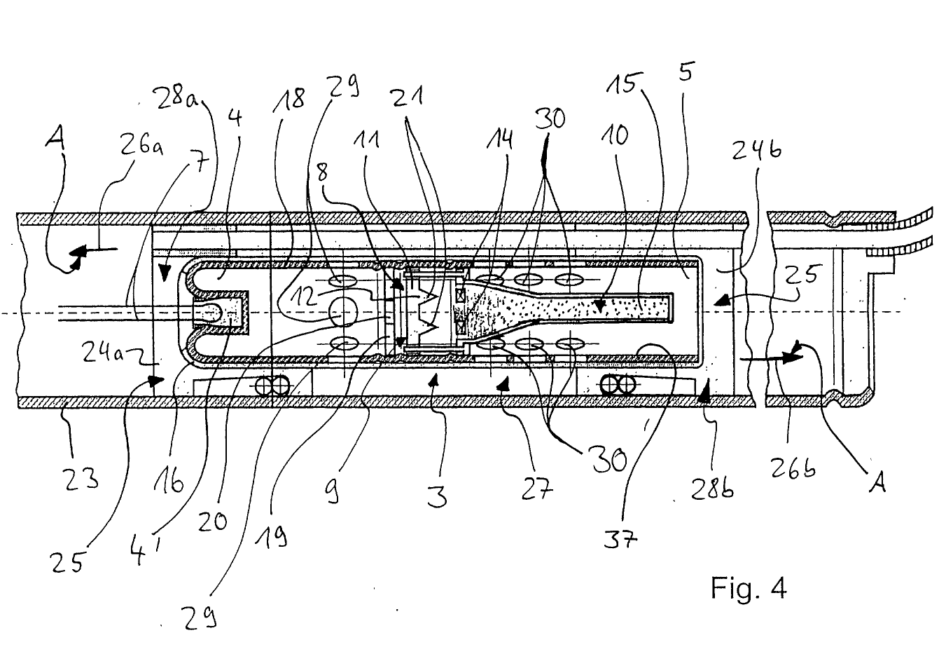

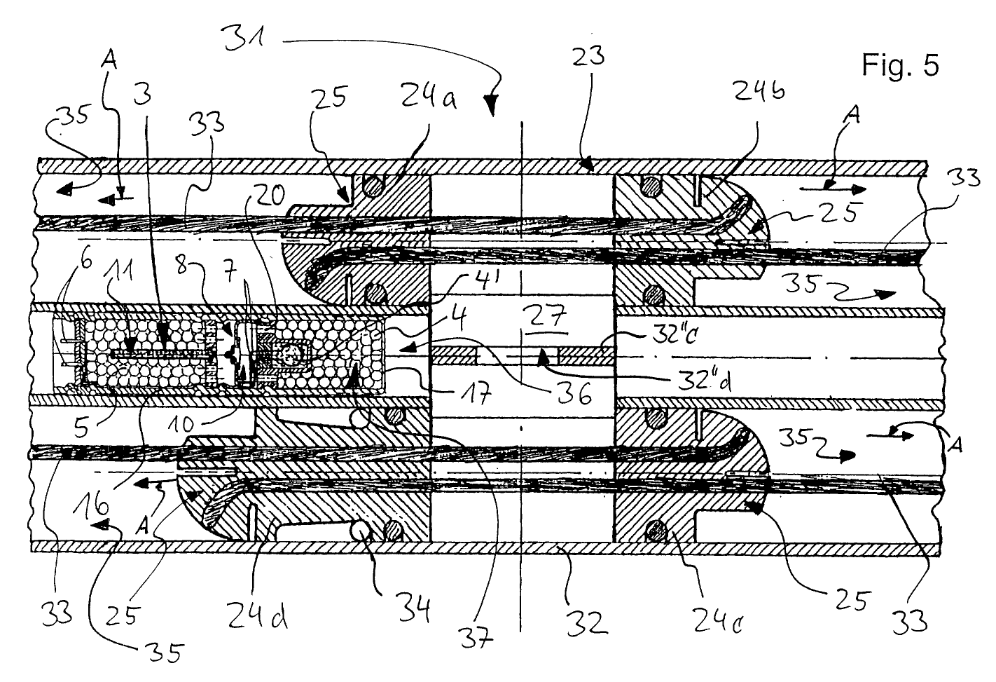

The representation of FIG. 2b shows the condition of the two-stage gas pressure generating devices 3, 5 ms after triggering. More precisely, up to this point in time, a triggering of the first driving stage 4 took place by way of the electric contacts 6 and the lines 7 as well as the electric igniter 4′. The triggering or ignition of the first driving stage 4 results in the housing 16 ripping open at its weakest point. The front wall 17 has a thinner construction than the peripheral wall 18 and a boundary wall 19 which faces the second driving stage 5 to provide the weakest point. The gas generated in the first driving stage 4 exits through the torn-open front wall 17 and into a pressure receiving space of a guide housing of at least one driving element for operating safety devices not shown here; a description appears below, for example, concerning FIGS. 4 and 5.

In the boundary wall 19 of the first driving stage 4, gas passage ducts 20 through which gas can also pass are situated. This gas flow from the first driving stage 4 results in a gas pressure which acts upon the ignition piston 12. The valve 13 is placed from that side onto the ignition piston 12 which is acted upon by this gas pressure of the first driving stage 4, and is therefore held in a closed condition by this gas pressure from the first driving stage 4. This gas pressure from the first driving stage 4 therefore causes the ignition piston 12 to be accelerated toward the second driving stage 5, where it impacts on the igniter 14, triggering the latter. In the illustrated embodiment, the valve 13 is designed such that it also forms an ignition pin 21 which, during movement of the ignition piston 12 to the second driving stage 5 and therefore to its igniter 14, impacts on the latter. This impacting onto the igniter 14 already at least loosens the valve 13 or even partially opens it.

An ignition of the chemical ignition retarder 15 of the chemical retarding and triggering devices 10 in the second driving stage 5 now takes place by way of the igniter 14. This chemical ignition retarder 15 requires approximately 2 ms before it ignites the second driving stage 5, which is illustrated in FIG. 2c. The gas pressure generated in the second driving stage 5 spreads and results in a gas flow through the weakest point which is formed by the already loosened or even partially opened valve 13. This, therefore, exposes a valve opening 22 in the ignition piston 12. Since the valve 13 no longer hinders the gas flow from the second driving stage 5, the corresponding gas pressure can expand through the open valve opening 22 and further through the gas passage ducts 20 in the boundary wall 19 of the first driving stage 4 into the latter. The gas pressure can then be made available through the burst front wall 17 and outside the cartridge housing 16 in a pressure receiving space of a guide housing for at least one driving element for operating safety devices not shown here; a description appears below, for example, concerning FIGS. 4 and 5.

The flash signs in FIGS. 2b and 2c symbolically represent ignitions or explosions.

The sequence illustrated in FIGS. 2a to 2c can be summarized as follows.

Beginning from the starting condition in FIG. 2a, an electric ignition of the first driving stage first takes place, whereby the ignition piston 12 is acted upon, for example, by way of holes in a bottom wall of the first driving stage 4. This ignition piston 12 impacts on a mechanical igniter 14 which may be connected with a booster or charge amplifier (not shown). Such a booster may also be used as a chemical ignition retarder 15 and may be designed such that, as required, it retards the ignition of the second driving stage 5. After the explosion of the second driving stage 5, the thus generated gas flows through the valve opening 22 in the ignition piston 12, in which case a multiplicity of such valve openings 22 may be provided in the ignition piston 12 or past it. Because of the construction in FIGS. 2a to 2c, the ignition piston 12 may also be called a two-part ring piston which consists of a ring-shaped piston part or outer ring and the valve 13 as an inner part with the ignition pin 21. This inner part may also be called an igniter pot and, in the example discussed here, is composed of an inner ring with the ignition pin 21. The inner part is pressed by the pressure gas out of the actual ignition piston 12 acting as the outer ring and exposes the path of the gas by way of the bottom holes or, more generally, the gas passage ducts 20 of the first driving stage 4. The above-described mechanical ignition, due to impact, for the second driving stage 5 is controlled by the two-part construction, for example, in the form of a double ring as a valve, since the valve is pressure-sealed in the direction of impact ignition and releases the gas in the opposite direction.

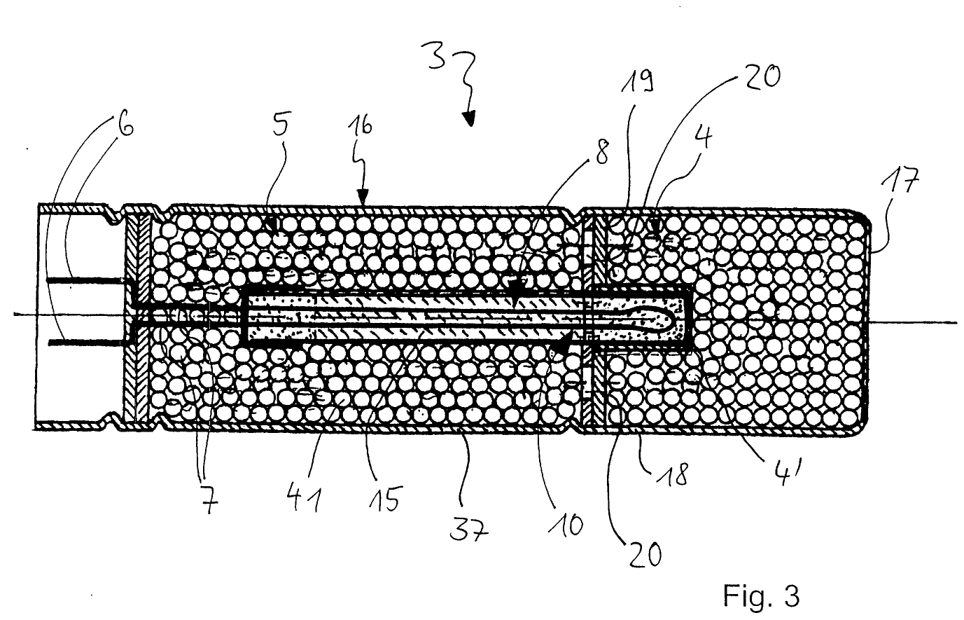

FIG. 3 is a schematic sectional view of a second version of a gas generating device to be used as a component in the inventive system. In this version, the first and second stages are coaxially aligned and axially arranged end to end without any axial space between them. In contrast to the preceding construction, which is illustrated in FIGS. 2a to 2c, the triggering control 8 contains only chemical retarding and triggering devices 10. For this purpose, a chemical ignition retarder 15 is provided which is ignited automatically in response to the burning of the first stage while burning of the first driving stage 4 occurs. The electric ignition of the first driving stage 4 may simultaneously also ignite the chemical ignition retarder 15. The time by which the ignition of the second driving stage 5 is retarded is exclusively the result of the burning time of the chemical ignition retarder 15. Finally, according to another alternative, the chemical ignition retarder 15 may also not be ignited until the very end of burning of the first driving stage 4. The remaining construction of this embodiment of gas pressure generating device 3 is analogous to the construction illustrated in FIGS. 2a to 2c in that it is mounted in a cartridge and has a front thin wall. In particular, the gas flow and, therefore, the spreading of gas pressure takes place from the second driving stage 5 through the gas passage ducts 20 in the boundary wall 19 of the first driving stage 4. The gas flow then goes through the latter and finally through the front wall 17 and outside of the cartridge housing 16 into a pressure receiving space of a guide housing for at least one driving element for operating a safety device not shown here; a description appears below, for example, concerning FIGS. 4 and 5.

FIG. 4 is a schematic sectional view of a subassembly of an operating system for vehicle safety devices according to the invention showing two driving pistons being driven from gas generated from a single two-stage canister or cartridge. FIG. 4 shows a gas pressure generating device 3 as a component of the operating system according to the invention for vehicle safety devices. As mentioned above, such operating systems may be, for example, belt tightening devices for seat belts, but also may be other mechanical adjusting devices, such as, for example, devices for withdrawing steering columns and steering wheels, or tilting seats or seat parts in the event of accidents.

FIG. 4 illustrates a two-stage gas pressure generating device 3, like those of FIGS. 2 and 3, accommodated in a housing 16, which in turn is mounted in a guide housing 23. In place of the gas pressure generating device 3 shown in FIG. 4, a gas pressure generating device as described in FIGS. 2a to 2c and 3 may be used.

As indicated in the sectional representation of FIG. 4, two pistons 24a and 24b (driving elements) are also accommodated or mounted in the guide housing 23, which serves as a cylinder for the pistons, for reciprocal movement. The pistons 24a and 24b represent driving elements 25 and can be moved along operating paths according to the arrows 26a and 26b.

The gas pressure generating device 3 and a pressure receiving space 27 are arranged between the two pistons 24a and 24b. Gas pressure which is generated by the gas pressure generating devices 3 expands into the pressure receiving space 27. When generated, this gas pressure acts upon the two pistons 24a and 24b to move them out of their at-rest positions 28a and 28b illustrated in FIG. 4, along their operating paths (arrows 26a and 26b).

In contrast to the first and second embodiments according to FIGS. 2a to 2c and 3, the gas outflow from the gas pressure generating devices 3 does not take place through the front wall 17 of the cartridge housing 16, but through the gas outlet openings 29 in the peripheral wall 18 of the cartridge housing 16. The triggering control 8 of the present component is constructed similar to the version shown and described in FIGS. 2a to 2c. First mechanical retarding and triggering devices 9 are operated by the pressure gas from the first driving stage 4 by an ignition piston 12 which is acted upon to move toward the second driving stage 5, where it impacts on the igniter 14 of the second driving stage 5. This igniter 14 first allows an ignition retarder 15 to burn down. At the end of its burning duration, the retarder causes the ignition of the second driving stage 5 itself. However, in this version, the gas outflow from the second driving stage 5 does not take place through a valve in the ignition piston 12, as in the second embodiment according to FIGS. 2a to 2c, but by way of separate gas outlet openings 30 in the peripheral wall 18 of the cartridge housing 16 for the second driving stage 5.

Through these gas outlet openings 30, the pressure gas from the second driving stage 5 also arrives in the pressure receiving space 27, where it contributes to the action upon the two pistons 24a and 24b in addition to the residual pressure which still exists in the pressure receiving space 27 from the generation of gas by the first driving stage 4. The residual gas pressure from the first driving stage 4 is added to the rising gas pressure from the second driving stage 5, so that a longer lasting high pressure level is maintained in the pressure receiving space 27. As a result, the two pistons 24a and 24b can be acted upon by a force which remains at least approximately constant for a longer time than if only one propelling charge were ignited. The latter would lead to a high pressure peak which would clearly be above the pressure level implemented according to the invention if, by one propelling charge, the same total force were to be made available for driving the pistons.

As a special characteristic of the component version illustrated in FIG. 4, it should also be taken into account that the ignition piston 12 of the ignition triggering mechanism 11 has two ignition pins 21 by which, in an aligned manner, two igniters 14 are provided for the chemical ignition retarder 15. This has the advantage that the ignition of the ignition retarder 15 takes place more reliably than if only one ignition pin igniter combination were present.

For the sake of completeness, it is also pointed out that, as an alternative or in addition to the possibilities for retarding the triggering of the second driving stage 5 mentioned above, other suitable implementations can be used, such as screens (not shown) for limiting the gas flow from the first to the second driving stage 4 and 5, in order to control the action upon an ignition piston 12 by mechanical retarding and triggering devices 9. Spacers (not shown) with desired breaking points between an ignition piston 12 and an igniter 14 can also be used. In this way, the ignition piston 12 is not set in motion toward the igniter 14 before a defined force is applied in the first driving stage 4 which is sufficient for destroying the desired breaking point of a spacer and thus opening up the path to the igniter 14 for the ignition piston 12. The important point is that there is only one initial ignition, and thereafter, the ignition of the second stage takes place automatically with the desired predetermined delay.

Several preferred design possibilities will be described in the following only as examples in order to gain a better appreciation of the invention.

An electrically ignited cartridge as a first driving or triggering stage 4 is arranged in the same housing 16 with an oppositely situated cartridge which is to be ignited mechanically as a second driving or triggering stage 5. The pressure surge of the first cartridge impacts on an ignition piston 12 with, for example, two ignition pins 21 and thus ignites the second cartridge (compare, for example, FIG. 4). For regulating the pressure surge and therefore a time delay, for example, a screen can be inserted as a throttle. As a result, the second stage 5 aids the first stage 4 such that a uniformly high pressure surge, which lasts as long as possible, drives the pistons as is illustrated schematically in FIG. 1.

The double or multiple cartridge can be called an adjusting device and, within the scope of the invention, can have an inner wall which is perforated for the gas outflow. An outer thin-walled sleeve can, for example, be slipped over, glued on to protect against entry of moisture and flanged. The outer sleeve can be so thin-walled that the pressure surge rips it open through the holes in the interior wall As illustrated, for example, in the third embodiment shown in FIG. 4, the double cartridge can be disposed in and between the pistons.

The invention can be applied basically to all types of seat belt tensioning devices and other safety devices, particularly in automobiles. Examples include a buckle tightening device, an automatic belt tightening device, a belt end fitting device, movement of seat ramps, knee paddings, brake pedals, cargo locking devices, steering system position changes, and so on.

In particular, an operating system according to the invention that includes as a component two-stage gas pressure generating devices can also be used in connection with seat belts in which, for improved comfort, the lap belt and the shoulder belt are rolled up by separate automatic mechanisms. Optimal safety can be achieved if the belt is tightened back simultaneously on both automatic devices or one automatic device and one end fitting or belt buckle. This is permitted by the present invention at reasonable cost and individually, since the new type of special tightener tightens back on both automatic devices, that is using two driving elements. As a result of a pressure level which is constant longer than that of one-stage gas pressure generating devices and which can be created by multi-stage gas pressure generating devices, the belt tightener driving elements, which are applied to both automatic devices, can be operated by joint gas pressure generating devices.

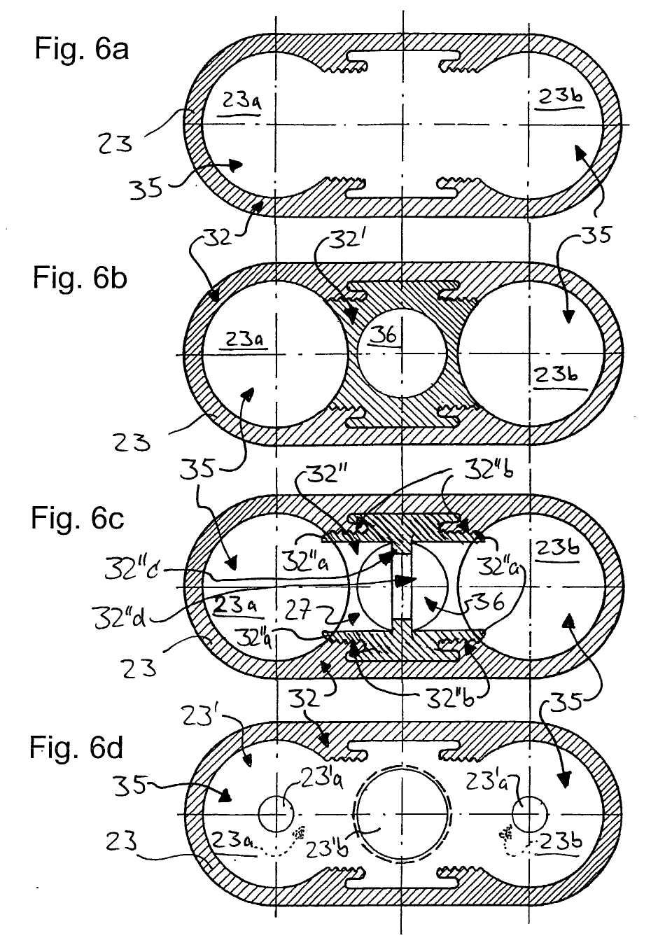

Another subassembly of an operating system for safety devices of a vehicle is illustrated in FIGS. 5, 6a, 6b, 6c and 6d. This version is a quadruple belt tightening device 31 which is housed in an extruded profile 32, is made of light metal and has one gas pressure generating device 3 for all four pistons 24a, 24b, 24c, 24d. The device 3 can be anyone of the gas pressure generating devices 3 heretofore described. As shown in FIG. 5, device 3 is the device of FIGS. 2a to 2c. In contrast to seat belt tighteners in the form of individual apparatuses, one for each seat belt, which are currently common, the integral combination of several driving elements within one housing a shown in these Figures that requires only one pyrotechnic cartridge or action and only one electric control circuit is a novel concept of the present invention.

FIG. 5 illustrates the core of such a quadruple belt tightening subassembly 31 according to the invention which has four pistons 24a, 24b, 24c, and 24d. In this case, the pistons 24a, 24b, and 24c are shown as having the purpose of driving an automatic seat belt mechanism (not shown) by Bowden cables 33, one cable associated with each piston, respectively. The piston 24d can be designed for tightening, for example, an end fitting of a belt (not shown) because it has a conventional ball lock 34 which locks the piston 24d once the end position of its operating path is reached preventing reverse movement of the piston. Between the piston ducts or guide paths 35, which are constructed in an integral manner with one another essentially as a double-run guide housing 23 for the individual pistons 24a, 24b, 24c, and 24d, a cartridge duct 38 forming a pressure receiving space 27 is situated with all the pistons exposed to the space 27 so that all receive the gas pressure. This duct is provided with a two-stage cartridge 37 as a two-stage gas pressure generating device 3, as shown in FIG. 2, and itself is also integrally constructed or assembled with the piston ducts 35. The guide housing 23 can, for example, be made of an extruded light metal profile. Two piston ducts or guide paths 35, respectively, are housed in opposite directions in a run 23a, and 23b of the double-run guide housing 23, so that the two runs 23a and 23b provide the four piston ducts or guide paths 35. This construction provides the advantage that, for machining, only cut lengths of different extruded light metal profiles need to be fitted together and positioned, for example, by clinching.

FIGS. 6a, 6b, 6c and 6d are four sectional views of the extruded profile 32, in its longitudinal course, as used for quadruple belt tighteners 31 of FIG. 5. FIG. 6a is a sectional view of the double-run guide housing 23 for the individual pistons 24a, 24b, 24c, and 24d. As indicated from FIG. 5, two piston ducts or guide paths 35 respectively coaxially extend behind one another, axially spaced, in opposite directions. The extruded profile 32 virtually has double runs and can receive four pistons 24a, 24b, 24c and 24d which are inserted in opposite directions, in pairs, in each run 23a and 23b of the double-run guide housing 23.

The cartridge duct 36 which, according to the representation in FIG. 5, is equipped with a two-stage cartridge 37 as two-stage gas pressure generating device 3, is formed by a separate extruded profile 32′ which is inserted into the double-run guide housing 23 between the two runs 23a and 23b which form the piston ducts or guide paths 35 situated opposite one another in pairs. In addition to receiving the cartridge 37, the extruded profile 32′ supplements the shape and thus increases the stability of the pure guide housing 23.

Another extruded profile 32″ forms the portion of the pressure receiving space 27 which directly adjoins the cartridge duct 36 and is illustrated in FIG. 6c. This extruded profile 32″ is designed such that it guides the pyrotechnic pressure into both runs 23a and 23b of the guide housing 23, and thus behind, onto the faces of all four pistons 24a, 24b, 24c and 24d. In addition to guiding the pressure gas from the cartridge 37 to the four pistons 24a, 24b, 24c and 24d, the extruded profile 32″ also supplements the shape and thus increases the stability of the pure guide housing 23. Furthermore, the extruded profile 32″ is used for positioning the four pistons 24a, 24b, 24c and 24d by stops 32″a. The sealing off of the pressure receiving space or explosion space 27 takes place by labyrinth seals 32″b. The extruded profile 32″ contains a web 32″c in which a pressure compensation hole 32″d is situated The pressure compensation hole provides a uniform pressure distribution in the pressure receiving space 27, and particularly in the two runs 23a and 23b of the guide housing 23.

For a closure, the guide housing 23 has one lid 23′ respectively at each end, one of the lids being shown in FIG. 6d. The lid 23′ can be produced as a disk of another extruded profile. This lid 23′ has passages 23′a for Bowden cables 33 and an opening 23′b for the cartridge 37 to be inserted last during the manufacturing of the quadruple belt tightener 31. It is sufficient for only one of the two lids 23′ for a quadruple belt tightener 31 to have an opening 23′b, but, for reasons of more efficient manufacturing, each lid 23′ may be provided with an opening 23′b, the opening 23′b in one of the two lids 23′ being closed without a previous inserting of a cartridge 37. The lids 23′ are clinched to the extruded profile 32 of the guide housing 23 and, as a result, also hold the extruded profiles 32′ and 32″ in place.

Without any limitation, in the invention, instead of a subassembly with four pistons or driving elements, in general, any other plurality of driving elements can be combined. Furthermore, it is not absolutely necessary within the scope of the invention to provide the guide housing for the multiplicity of the driving elements in one piece; several individual guide housings may be used and assembled to an integral unit. Finally, the multi-stage gas pressure generating devices 3 as a component of the invention are not limited to use in connection with a plurality of driving elements but can also be used for acting upon only one driving element.

Although the gas pressure generating device 3, shown in FIG. 5 is the version of FIGS. 2a, 2b, 2c, another version can be substituted. For example either of the versions shown in FIGS. 3 and 4 can be used in the subassembly of FIG. 5.

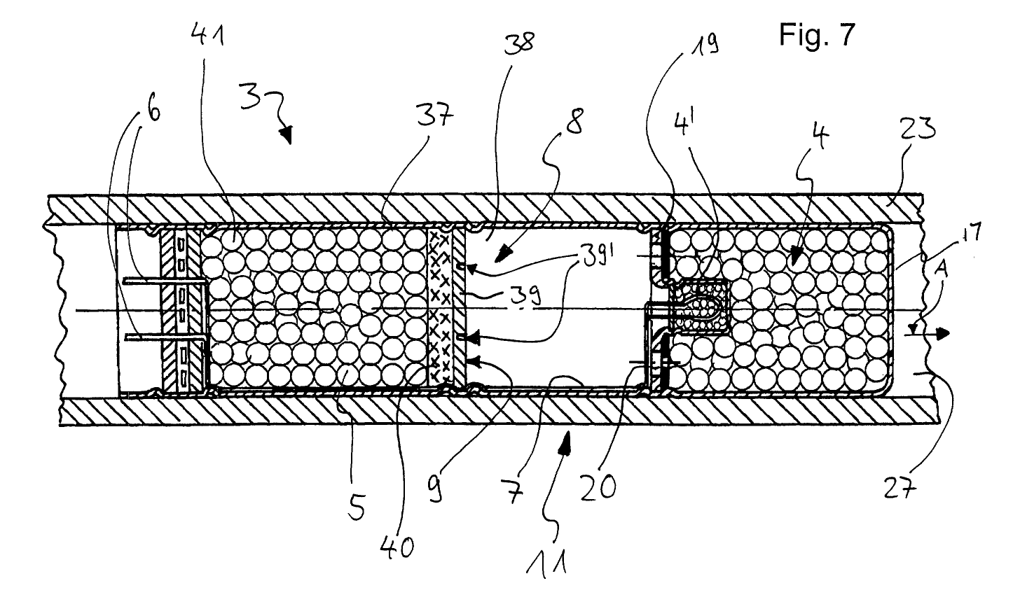

FIG. 7 is a sectional view of a further version of a gas pressure generating device 3 which contains a two-stage cartridge 37 with the stages arranged coaxially and in spaced axial relation. The second stage 5 is ignited automatically with a 2 ms delay and responsively after the first stage 4 has been ignited. The automatic ignition of the second driving stage 5 is triggered by way of a triggering control 8 which contains mechanical retarding and triggering devices 9. Without limitations, reference is made, with respect to common parts and characteristics of this version, to the above descriptions of the first to fourth versions and corresponding FIGS. 2a, 2b, 2c, 3, 4 and 5, in order to avoid repetitions.

The triggering or ignition of the first driving stage 4 in this fifth version has the result that, through the at least one gas passage duct 20 in the boundary wall 19 closing off the first driving stage 4 toward the second driving stage 5, the gas generated in the first driving stage 4 flows out through thinned end wall 17 not only into a pressure receiving space 27 (compare FIG. 5 as well as well as 6a, 6b, 6c and 6d) of a guide housing 23 (compare FIG. 5 as well as 6a, 6b, 6c and 6d) for at least one driving element 25 (compare FIG. 5 as well as 6a, 6b, 6c and 6d) for operating safety devices (not shown), but also flows out into a pressure collection space 38 which is situated between the first driving stage 4 and the second driving stage 5 and forms part of the ignition triggering mechanism 11 of the mechanical retarding and triggering devices 9. The latter also contain a bursting plate or disk 39 that closes off the pressure collection space 38 in the two-stage cartridge 37 toward the second driving stage 5.

The bursting plate 39 contains weakenings or weak points 39′ in the form of thin points at which the bursting plate 39 breaks at a defined gas pressure in the pressure collection space 38. So that a sufficient moving path is available for the breaking or bursting operation of the bursting plate 39, a free or soft zone 40 is provided between the latter and the actual second driving stage 5, in which steel wool, for example, may be situated. Instead of the bursting plate 39, a spring-braced or otherwise designed valve (not shown) may also be provided which opens up at a defined gas pressure in the pressure collection space 38. Through the burst bursting plate 39 or a corresponding valve (not shown) and the free or soft zone 40, hot pressure gas of the first driving stage 4 directly reaches the motive agent 41 of the second driving stage 5 and ignites this motive agent 41 and thus the second driving stage 5.

The gas generated by the second driving stage 5 after its ignition spreads through the free or soft zone 40, the bursting plate 39, whose fragments are possibly pressed into the pressure collection space 38, the pressure collection space 38 and the burned first driving stage 4 into a pressure receiving space of a guide housing for at least one driving element for operating safety devices not shown here; a description appears above, for example, concerning FIGS. 4 and 5 as well as 6a, 6b, 6c and 6d. The boundary wall 19, which closes off the first driving stage 4 toward the second driving stage 5, is preferably designed such that it is pressed away by the gas pressure of the second driving stage 5 and thus opens up the path for this gas flow unhindered into the first driving stage 4.

Double-igniting cartridges as described herein as a component of the invention, for example, are very advantageous in the case of gas pressure generating devices of, for example, pyrotechnic drives for belt tighteners. As a result of a double explosion at an interval of, for example, 2 ms, the pressure receiving space or explosion space can be filled twice successively with pressure gas. During the first ignition, a smaller amount of gas is formed because the explosion space is still small in comparison to its later dimensions after the driving element, such as a piston, has moved. The movement of the piston, in which case, without limitations, preferably several pistons may also be acted upon simultaneously, enlarges the explosion or pressure receiving space in which then, in a time-delayed manner, as the result of the second explosion or ignition, for example, the same peak pressure can be reached, but with a larger amount of gas than in the first stage. Thus, the second stage generates a greater volume of gas than the first stage. As a result of the longer-lasting pressure level, for example, three times the amount of energy can be entered into the operating system to control belt tightening, which, without being stressed more itself, can carry out a correspondingly larger amount of work.

Further embodiments of the invention will be illustrated in the following figures of the drawing, in which case as well as with respect to the design of the quadruple belt tightener according to FIG. 5 as well as 6a, 6b, 6c and 6d, designs and characteristics exceeding the multiple-stage drive are also in each case of novelty significance and deserve to be protected particularly also together with one-stage operating systems and processes. This particularly applies to the design of the operating system with several driving elements, particularly pistons, and with load limiting devices for the driving elements.

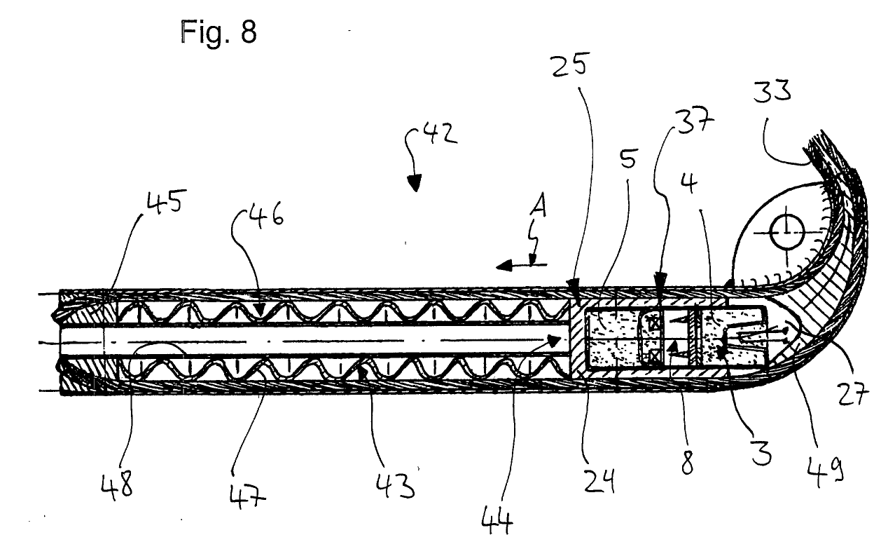

With reference to FIG. 8, another subassembly will be explained only as an example by way of a pyrotechnic actuated tightener 42, particularly for tightening seat belts (not shown), the subassembly being characterized by including a load limiting device 43.

A load limiting device is one that lowers the load upon an occupant when, after a collision, this occupant is pressed too severely against his/her seat belt. The process takes place as follows. During a collision, the tightener of the seat belt is activated in order to eliminate the slackness of the belt. For this purpose, the seat belt is tightened by a force exercised by the pressure gas from the gas pressure generating device by way of the driving elements. As the result of the collision, because of his or her inertia, the occupant is pressed against this force against the seat belt. If the force exerted by the occupant upon the seat belt becomes higher than the force which the belt tightener currently applies, the driving element would tend to be withdrawn again. However, if the driving element is prevented from moving backwardly, for example, by a ball lock 34 for the piston 24d described in connection with FIG. 5, the piston 24d is now abruptly braked, and an excessively high load is placed upon the occupant occurs because he/she is now pressed with full force against the seat belt. This loading is to be reduced by the load limiting device 43 that is a component of the combination of the invention, which will first be explained with reference to FIG. 8.

FIG. 8 shows a portion of a belt buckle tightening device 44 with gas pressure generating device 3 in the form of a two-stage cartridge 37, shown schematically. Device 3 is like the version described in conjunction with FIGS. 2a-2c with one modification; it is provided with two ignition pins 21 in the manner of the version shown and described in FIG. 4. It is also possible to use a version as shown in FIG. 3 or 4 or 7. Since device 3 has been explained in detail, in order to avoid repetitions with respect to FIG. 8, details of the gas pressure generating devices 3 will not be further elaborated upon.

In the portion of the belt buckle tightener 44 illustrated, a cable linkage does not, as is customary nowadays, link directly to the piston 24 acting as the driving element 25. A thimble 45, axially spaced from piston 24, serves for linking (anchoring) the cable, such as a Bowden cable 33, for transmitting the movement from the driving element 25 to a belt buckle (not shown). In the axial space between the piston and the thimble extends a load-absorbing device 46, in the form of an elongated corrugated tube, engaging or fixed to the piston at one end and to the thimble at the other end. The load-absorbing device has the purpose of reducing load peaks when the piston is locked by a return blocking device (not shown) with respect to a withdrawal which occurs because the force which the occupant exercises upon the seat belt is higher than the force which is available for the movement of the piston 24.

The example of FIG. 8 shows a deformable corrugated pipe 47 which folds up under a load. The corrugated pipe 47 is sufficiently rigid and is connected between the piston 24 and the thimble 45 so that, by way of the corrugated pipe 47, the piston 24 pushes the thimble 45 ahead of itself when it is acted upon with pressure gas from the gas pressure generating device 3. Because of a counterforce on the Bowden cable 33 against the pull by the force of the occupant onto the seat belt (not shown), when the piston 24 is blocked against a withdrawal, the deformable corrugated pipe 47 can fold up under the load of the thimble 45 acted upon by the occupant by way of the seat belt (not shown) via the Bowden cable 33. This ensures that no abrupt peak load is exercised on the occupant when the piston 24 is blocked against a return and the occupant continues to press increasingly against the seat belt (not shown). This further reduces the risk of injury to the occupant.

The thimble 45 slides on and is guided by a guiding tube 48 so that the system will not buckle. The corrugated pipe 47 is only one example of a load-absorbing device 46, such as a deforming element. According to the desired characteristic load curve (constant, rising, stepped), nesting elements and inhomogeneous structures (pipes with slots, corrugated pipes of different wall thicknesses, etc.), are examples of conceivable deformable elements that can serve the load limiting function.

As mentioned above, the belt buckle tightener 44 is equipped with a two-stage cartridge 37 or, more generally, a multi-stage cartridge. The end-side seal 49 of the piston duct or guide path 35 and the simultaneous cable guidance by a corresponding edge design of the piston 24 are further cost-saving elements.

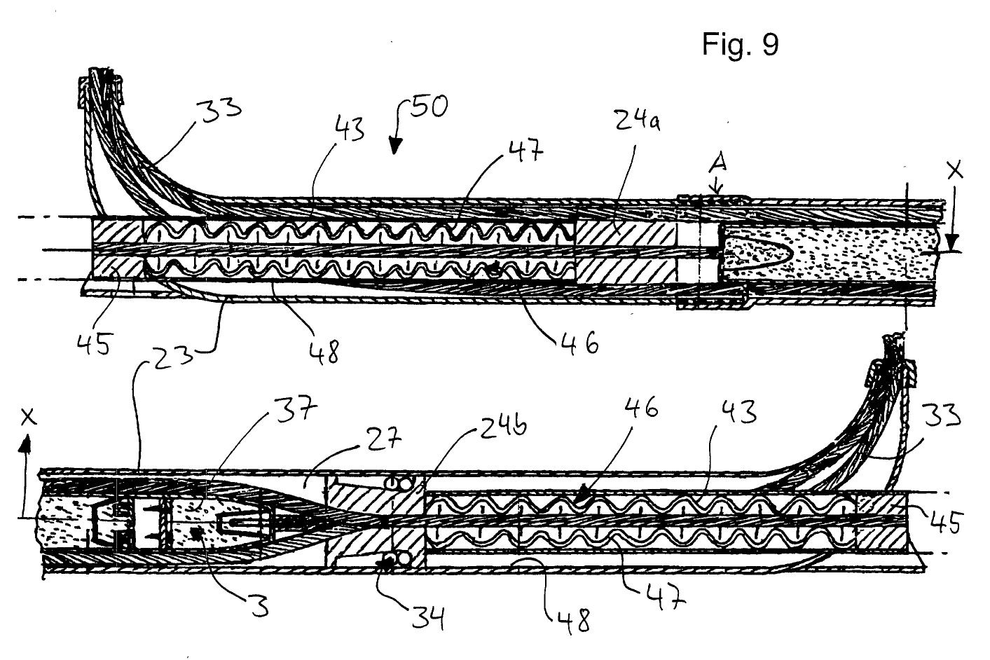

FIG. 9 shows an assembly consisting of a double piston tightener 50 which is particularly suitable for the application to seat benches (not shown) and for the tightening of belt buckles (not shown). Both pistons ducts or guide paths 35 for the two pistons 24a, 24b are, detachably from one another in the center, see arrow A, connected with one another, for example, by threads. This connection is used for breaking the assembly apart and the inserting of the pyrotechnic cartridge, such as the illustrated two--stage cartridge 37, in the last pass during manufacturing of the double piston tightener 50. In addition, the cartridge can be changed in this manner the event of a determined functional disturbance or a malfunction.

As in FIG. 8, gas pressure generating devices 3 and load-absorbing devices 46 as load limiting devices 43 are also used here. The construction according to FIG. 9 has the advantage that it requires only one two-stage cartridge 37 for two belt tighteners with load limiting devices which have completely separate courses.

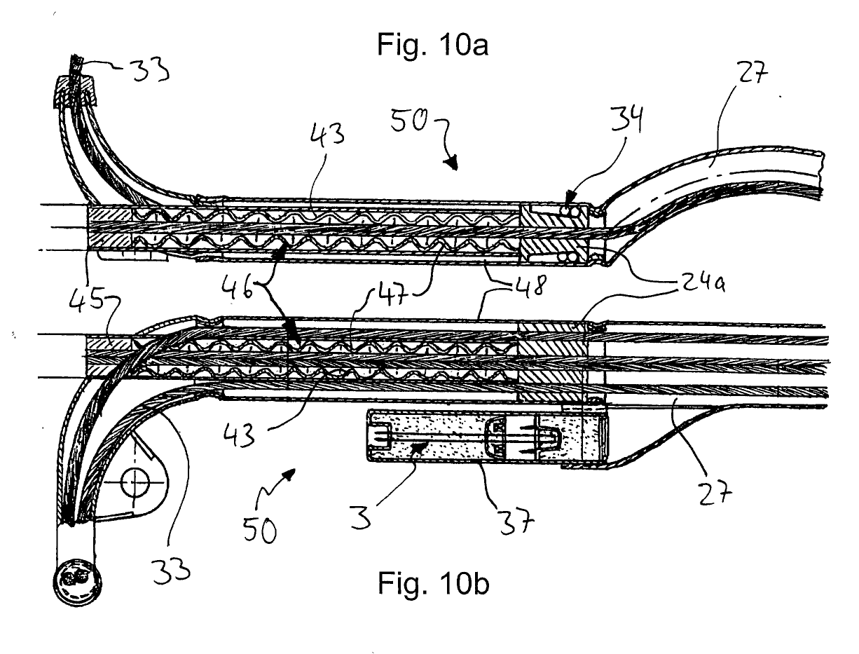

FIGS. 10a and 10b show a modification of the construction in FIG. 9 with an arrangement for difficult, particularly narrow, space conditions. In the design according to FIG. 10b, the gas pressure generating device 3, the version of FIG. 2 with two igniter pins 21, is arranged and mounted beside or next to the piston ducts or guide paths 35 for the two pistons 24a, 24b. Only one of the two pistons 24a is visible. The gas generating device 3 when ignited, feeds a pressure gas supply into space 27 between the two pistons 24a, 24b.

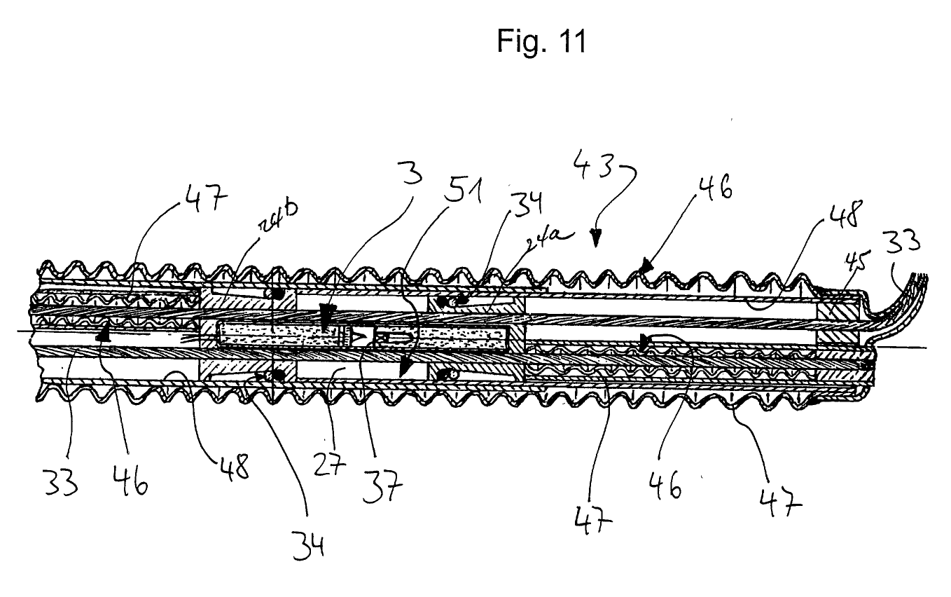

FIG. 11 illustrates in general an expansion of the load limiting to two levels. Shown is a partial assembly of the present invention wherein the components of the combination not relevant to the point being illustrated are shown either schematically or are omitted for clarity. Nonetheless, the illustration of FIG. 11 is intended to include the entire combination of components are heretofore described. For example, the device 3 is the device of FIGS. 2a-2c and the arrangement is to feed the generated gas into the common space 27, even though the details have been omitted for clarity. In FIG. 11, the load limiting devices as shown and generally designated as 43 can be understood from the explanations made above with reference to FIGS. 8, 9 and 10. What is particularly illustrated in FIG. 11 is the possibility of telescoping divided cylinder pipe 51 constituting the exterior shell or cylindrical housing for the driving elements 24a and 24b, the load limiters 46 associated with the driving elements 24a and 24b, the thimbles 45 and the intermediate device 3. As shown, the Bowden cables 33, connected at one end to the safety devices and at their other ends to thimbles 45, pass through the load limiters 46 (corrugated tubes). The load of this telescoping of pipe 51 is limited by a surrounding load-limiting or load-absorbing device 46 in the form of a deformable pipe, such as a corrugated pipe 47. The load limiting pipe must be displaceable in the sense that it can be shortened by deformation to relieve the stress. In general, that is, for all embodiments described above and in the following, other applications as tightening devices for belt buckles are also conceivable, as easily recognized by a person skilled in the art.

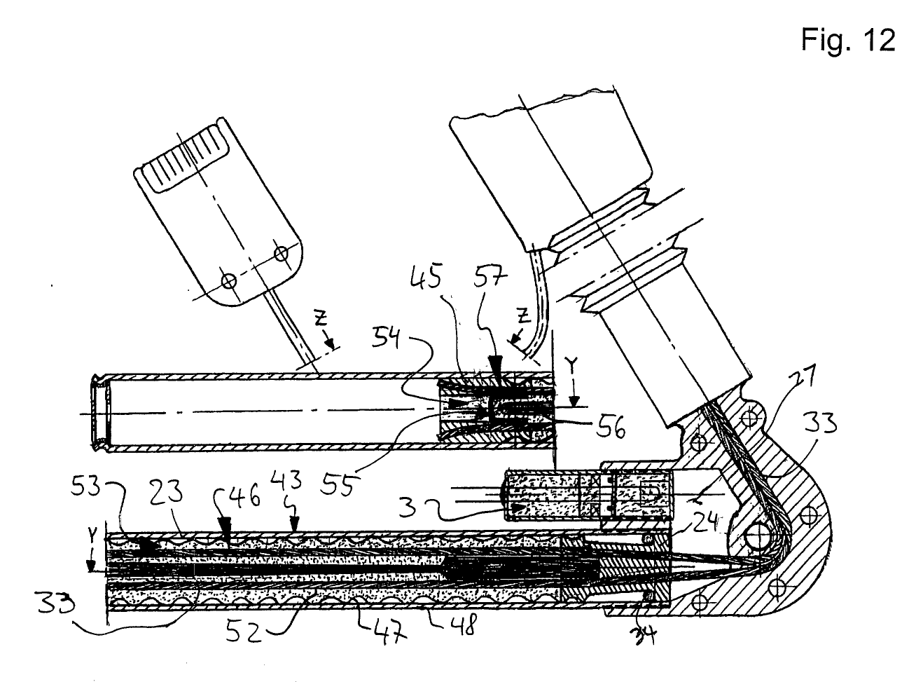

Other variants of load-limiting or load-absorbing devices 46 are “programmable” load limiting devices 43. This feature is described in the following with reference to FIG. 12, according to another aspect, shows the possibility of adapting the characteristic load curve of load-limiting or load-absorbing devices 46 individually, for example, to the requirements of occupants of different weights on different accident sequences and severity.

For this purpose, a hydraulic liquid 52, such as silicone oil or grease, particularly such a hydraulic liquid 52 with a low change of viscosity at temperature fluctuations, is situated, in the illustration according to FIG. 12, between the thimble 45 and the piston 24. In order to hold the hydraulic liquid 52 securely between the thimble 45 and the piston 24, the latter are tightly connected with one another by a corrugated pipe 47 to form a liquid tight chamber. The corrugated pipe 47 is flanged on its ends with the thimble 45 and the piston 24. As a result, the corrugated pipe 47, together with the thimble 45, and the piston 24, forms a container 53 for the hydraulic liquid 52, which can be deformed as previously described, and particularly upset along the connection line of the thimble 45 and the piston 24. The corrugated pipe 47 itself generates a part of the characteristic load limiting curve in the manner explained in connection with the embodiments according to FIGS. 8 to 11.

In the illustration according to FIG. 12, the deformation of the corrugated pipe 47 is controlled by the hydraulic fluid 52, as the fluid must be relieved in order that the pipe 47 can be deformed. The deformation is accompanied by a reduction in the volume of the chamber containing the fluid 52. To accomplish this effect, the thimble 45 has a nozzle 54 which, when not in use, can be tightly closed, for example, by a stopper 55. A nozzle needle 56 is fastened by an extension rod on the piston 24, the tip of the nozzle needle 56 pointing to the stopper 55 in the nozzle 54 of the thimble. When a load is exercised onto the thimble 45 against the blocked piston 24, the nozzle needle 56 pushes open the stopper or the closing cap 55 out of the nozzle 54 and moves through the nozzle 54 which has a larger diameter than the nozzle needle 56. As a result, the hydraulic liquid 52 is pressed through a ring gap formed between the nozzle needle 56 and the nozzle 54. According to the size of the ring gap, a counter-pressure is created which varies. Superimposed on the folded or deforming tube 47, this counter-pressure determines the characteristic load limiting curve. Along its longitudinal course, the nozzle needle 56 may be tapered or have different diameters and/or shapes, which affects the size and shape of the ring gap. As a result, the damping performance of the load limiting device 43 can be programmed and controlled.

In order to provide a facilitated passage for the hydraulic liquid, such as oil or grease, as an additional possibility, for example, in the event of an excessive pressure because of a serious accident or when the hydraulic liquid is very cold, a pressure relief valve 57, for example, in the form of an elastic sleeve, is situated in the thimble 45 in order to reduce unacceptable pressure levels. This pressure relief valve 57, as recognizable by a person skilled in the art, can also be constructed as a spring, a closing piston and/or a pressure piston in a controlling manner that provides relief upon the pressure exceeding a predetermined value.

The “programmable” load limiting device 43 according to the illustration of FIG. 12 is particularly simple and effective and otherwise could only be achieved at very high expenditures in the case of an automatic belt tightening device. Because of the simple construction, the load limiting device can be varied at low cost and to a very high degree. As noted previously, the illustration of FIG. 12 is only for the purpose of showing an additional feature of the combination of the invention and only a partial showing of the combination is presented. The device 3 is the device shown in FIGS. 2a to 2c modified as shown in FIG. 4 and has two ignition pins. The gas generated is fed into common space 27. Other aspects of the illustration of FIG. 12 have not been described in detail, as they are apparent from previous descriptions and have been omitted to avoid unnecessary repetitions, even though all components of the combination of the invention would be present in the construction of FIG. 12.

The above-explained features and partial arrangements illustrated in FIGS. 8 to 12 relate to a belt buckle tightening device 44 with a load limiting device 43 which contains a corrugated pipe 47 between the thimble 45 and the piston 24. When a pull is exercised on the belt (not shown), the corrugated pipe 47 is pulled together, that is deformed by collapsing or folding up the corrugations. By means of this construction, a definable or defined rising characteristic load curve can be implemented.

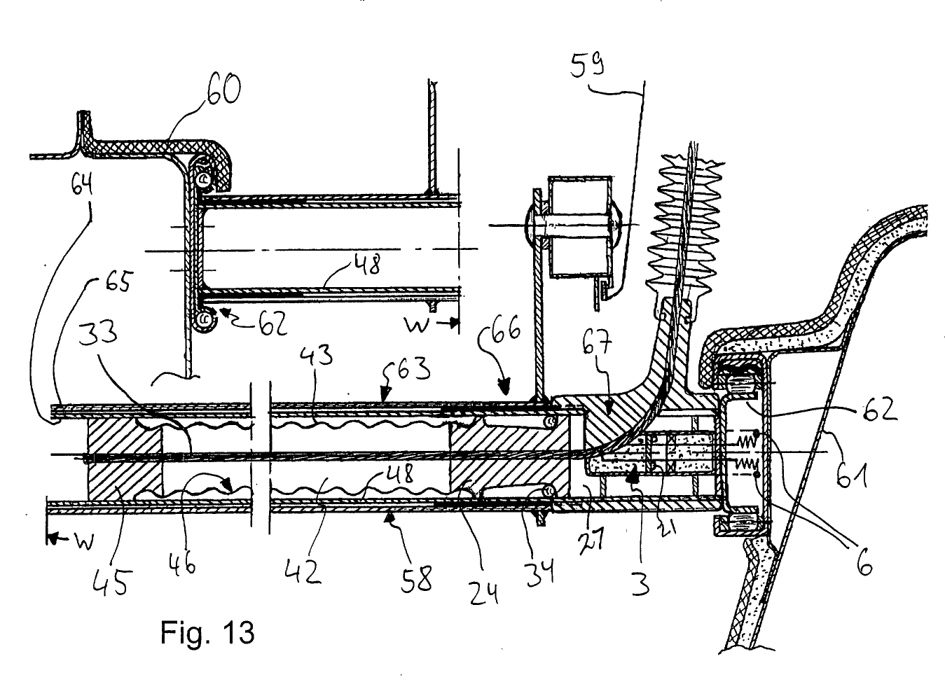

As another special characteristic, it is mentioned in the case of the variant feature illustrated according to FIG. 12 to connect the actual belt unlatching buckle by a Bowden cable with a locking buckle. This has the advantage that the unlatching buckle can be fixedly mounted on a movable seat so that it is always at the same site for the user. The “locking buckle” is mounted on the vehicle fixed seat bottom part. In another arrangement, a seat cross traverse 58 is provided which has incorporated therein an integrated belt tightening device 42 with a load limiting device 43 as has been previously described. The construction of the vehicle to accommodate and incorporate the combination of the invention is described in detail in the following with reference to FIG. 13. This variant relates to optimizing the safety requirements in the event of a side crash by the design and the arrangement of the seat structure and the belt tightener.

For optimizing the lateral stiffness of an automobile, as illustrated in FIG. 13, the supporting cross traverses of an individual passenger car seat 59 are placed as high as possible between a door sill 60 and a transmission tunnel 61. For this purpose, the runners 62 must be placed on edge. The cross traverse 56, which is in the rear in the driving direction, is constructed in a tube-shaped manner such that this tube can simultaneously operate as a housing 63 of the transversely arranged belt tightener 42 with the load limiting device 53. The housing 63 is fastened to the longitudinal guide rails 62. If, as in the illustrated example, the housing 63 consists of two tubes 64 and 65 fitted into one another, then this housing 63 is simultaneously used as a pivot bearing 66 for vertically adjustable seats 59. The deflection of the cables or Bowden cables 33 of the belt tightening device 42 can be implemented, for example, by a cast, divisible block 67 which is inserted into the inner tube 64 slotted for the passage of the cable 33. The electric feed lines (not shown) for the electric contacts 6 can be displaced in the seat rail 62. With regard to the combination of the invention, the various components have been generally illustrated in FIG. 13, but no detailed explanation is included as the same parts have been given the same reference numbers and their functions have been previously described in detail. For example, the device 3 is the two-stage device 3 of FIGS. 2a-2c as modified according to FIG. 4 to have two ignition pins 21. Similarly, other parts and components are identifiable from the illustration and reference numerals.

The additional advantages achieved by this construction are that the cross traverse of the seat is simultaneously used for stabilization against a side crash and receives the belt tightening device which, as a result, does not require any additional receiving space. In this case, the belt tightener housing is a supporting part for the seat structure and against a side crash. Space, weight and costs are saved as a result.

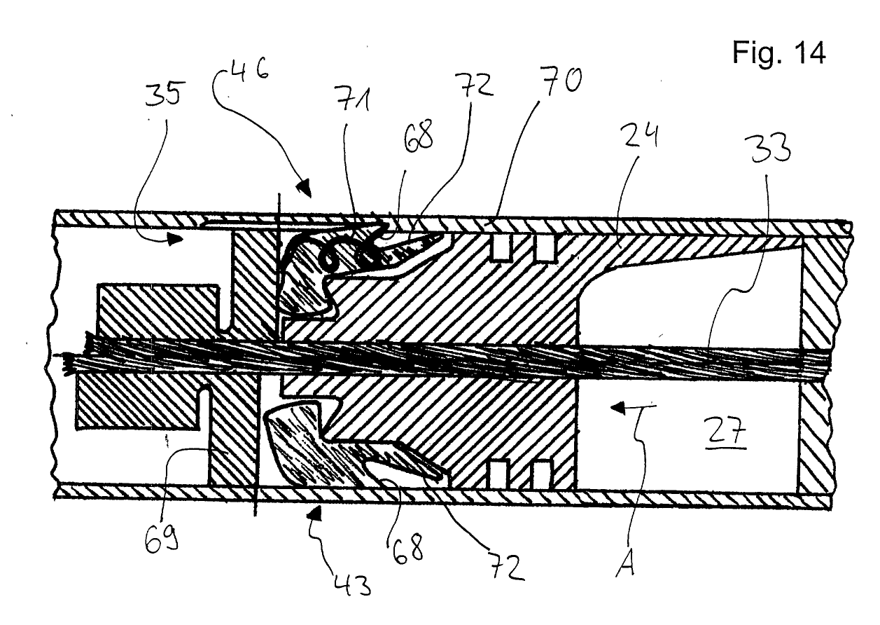

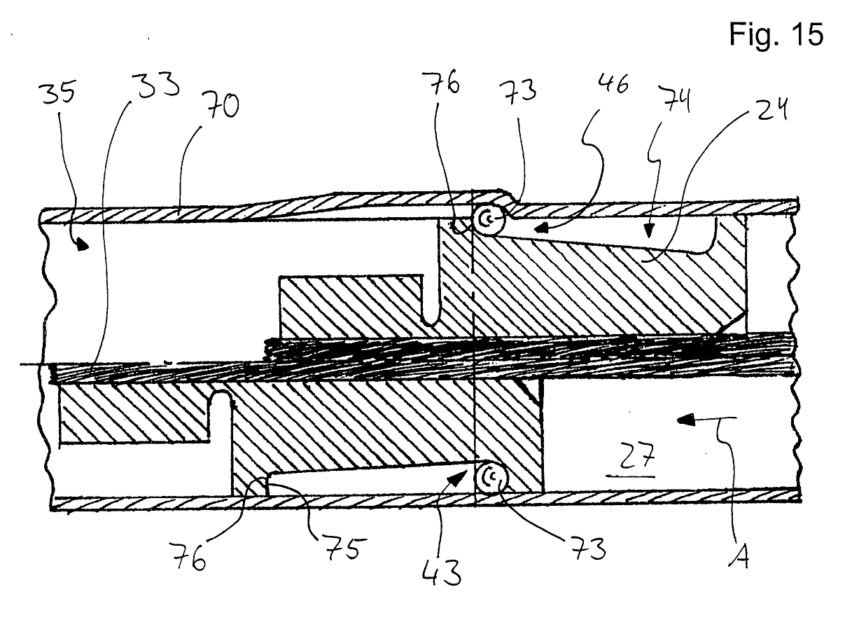

FIGS. 14 and 15 show additional arrangements for load limiting devices 43 of the inventive combination, with details unnecessary for an understanding of the aspects of the load limiting devices of FIGS. 14 and 15 have been omitted. However, it should be clearly understood that all components of the inventive combination are present and the features shown and described are incorporated into the inventive combination.

A cutting version of a load limiting device 43 is illustrated in FIG. 14 which is a partial assembly showing only the piston and the load limiter of the inventive combination of components. The load limiting device contains cutting blades 68 which are embedded in or mounted on the piston 24. The cutting blades 68 are mounted for rocking and are disposed to tilt so that, in the event of a pulling-back on the Bowden cable 33 by a tensile load by the occupant on the connected seat belt (not shown), when this load has become higher than the force onto the piston 24 by the action of the gas pressure generating devices 3 (not shown but included here), they are tilted out of the piston 24 by a driving plate 69. The return movement of the piston 24 has the result that the cutting blades 68 are pressed into the wall 70 of the piston duct 35 and dig in there (compare the lower half of the illustration with the upper half of the illustration). As a result of the reverse movement of the piston 24 against its loading direction according to the arrow A by the gas pressure generating devices 3, as illustrated by the upper half of the illustration, each of the cutting blades 68 peels a sliver 71 out of the wall 70 of the piston duct 35. The force required for this purpose dampens and limits the tensile force causing this action. The height of the sliver 71 is precisely limited by a contact surface 72 integrated in the cutting blade 68. The extent of the load limiting is determined by the, width and the height of the peeled-out sliver 71, the material of the wall 70, and the number of cutting blades 68. This results in a low-cost and space-saving construction of a load limiting device, for example, for a seat belt. This arrangement is incorporated in the combination of the invention, as previously described, in place of the corrugated pipe 47 and simplifies the combination of components. Note that the piston 24, in this case does not need a ball lock 34, also an advantage.

FIG. 15, which also only illustrates a partial assembly like FIG. 14, illustrates a load limiting device 43 which has a deforming effect. For this purpose, balls or rolls 73 are provided which are arranged in wedge spaces 74 on the edge within the piston 24. The wedge spaces 74 are designed such that, when the piston 24 moves forward, the balls or rolls 73 are taken along by the pressure gas from the gas pressure generating devices 3 (not shown but included here), without generating an effect. When the movement of the piston 24 is reversed, for example, because of the fact that the force of the occupant onto the seat belt (not shown) connected to the piston 24 by way of the Bowden cable 33 has become higher than the force of the gas pressure from the gas pressure generating devices (not shown here), the balls or rolls 73 are pressed, by self-energy and friction into the narrower area of their wedge spaces 74 and are jammed in there between the piston 24 and the wall 70. As a result of the materials used for the piston, the balls or rolls 73 and the wall 70, as well as the shape of the wedge spaces 74, a dent-type material deformation in the wall is created with an increasing withdrawal force onto the piston 24 by each ball or roll 73. At the narrower ends 75, the wedge spaces 74 are dimensioned and shaped such that holding shoulders 76 which project beyond the center line of the balls or rolls 73 are formed so that the latter are held in a form-locking manner and cannot slide through between the holding shoulders 76 and the deformed wall 70. This also results in a low-cost and space-saving construction of a load limiting device, for example, for a seat belt. Like FIG. 14, the modification for a load limiter can be used in the combination of the invention in place of the corrugated pipe 47.

In addition to the characteristics and combinations of characteristics indicated in the preceding description, the figures of the drawings and the claims, the present invention comprises, without limitation, all concepts, principles and generalizations which can easily be recognized by a person skilled in the art on the basis of his special knowledge. In particular, all variations, combinations, modifications and technical knowledge of a person skilled in the art are within the scope of the invention.

What is claimed is:

1. An operating system for a vehicle safety device comprising in combination;
(1) a housing defining at least one elongated duct and a common space in said duct,
(2) a driving element having a working face received in the at least one duct for reciprocal sliding movement with its working face exposed to said common space,
(3) a gas generating member comprised of an elongated cartridge mounted in the housing with one end of the cartridge exposed to communicate with the common space of the housing, said cartridge containing at least a first gas generating stage and a second gas generating stage, each stage containing pyrotechnic material capable of generating gas when ignited, arranged coaxially aligned and axially positioned one behind the other with the first gas generating stage adjacent the one end of the cartridge exposed to communicate with the common space of the housing, the cartridge wall being thinned in the location of the first gas generating stage such that upon ignition of the first gas generating stage generated gas bursts through the thinned wall into the common space of the housing, a first triggering member incorporated in the first gas generating stage that is triggered responsive to a vehicle experiencing a crash of a predetermined degree, and a second triggering member associated with the first and second gas generating stages that is triggered, with a predetermined delay, automatically by the gas generation of the first gas generating stage to generate in the second gas generating stage gas that flows out through the first stage and into the common space of the housing,
(4) a thimble member mounted in the at least one elongated duct for sliding movement and axially spaced from the driving member,
(5) a vehicle safety device,
(6) a cable connected at one end to actuate the vehicle safety device, extending into the at least one duct, bypassing the driving element and connected at its other end to the thimble member, and
(7) a load limiting member associated with the driving element and thimble to relieve an excess force imposed on the cable greater than the gas pressure imposed on the face of the driving element.

2. An operating system for a vehicle safety device according to claim 1 wherein the vehicle safety device is one of a seat belt tensioning device, a buckle tightening device, an automatic belt tightening device, a belt end fitting device, a seat ramp mover device, a knee padding device, a brake pedal device, a cargo locking device and a steering system position changing device.

3. An operating system for a vehicle safety device according to claim 1 wherein the housing has two driving elements received in said at least one elongated duct with the working faces of the driving elements arranged in opposition and both exposed to the common space, a thimble member and a load limiter associated with each driving element.

4. An operating system for a vehicle safety device according to claim 3 wherein each load limiter is comprised of a corrugated tube engaged at one end with its associated thimble and at the other end with its associated driving element.

5. An operating system for a vehicle safety device according to claim 1 wherein the load limiter includes a corrugated tube attached at one end to the thimble and at its other end to the driving element.

6. An operating system for a vehicle safety device according to claim 5 wherein the load limiter contains a hydraulic fluid, and the load limiter includes an exhaust opening through with the hydraulic fluid can escape during deformation of the corrugated tube.

7. An operating system for a vehicle safety device according to claim 6 wherein the exhaust opening is in the form of a nozzle.

8. An operating system for a vehicle safety device according to claim 7 wherein a needle valve is operatively connected to the driving element and is adapted to control the exhaust opening of the nozzle.

9. An operating system for a vehicle safety device according to claim 1 wherein the second triggering member includes an ignition pin and an igniter that are spaced axially with the ignition pin being driven into the igniter responsive to gas generated in the first gas generation stage.

10. An operating system for a vehicle safety device according to claim 9 wherein the second triggering member includes two ignition pins and two igniters.

11. An operating system for a vehicle safety device according to claim 1 wherein the load limiter is comprised of a cutting blade positioned adjacent the rear of the driving element axially opposite its working face such that in repose the cutting blade lies adjacent the inner surface of the duct, and responsive to the thimble being drawn toward the driving element, the thimble contacts the cutting blade and rocks it toward the inner wall of the duct forcing it to dig in a predetermined depth into the inner wall of the duct so that further movement of the thimble in the direction of the driving element causes a sliver to be peel from the inner surface of the duct.

12. An operating system for a vehicle safety device according to claim 1 wherein the gas generating member is carried by the driving member.

13. An operating system for a vehicle safety device according to claim 1 wherein the gas generating member is positioned in a duct in the housing.

14. An operating system for a vehicle safety device according to claim 1 wherein the housing defines a plurality of ducts with a driving element positioned in each duct.

15. An operating system for a vehicle safety device according to claim 1 wherein the housing is composed of two parts detachably connected together, and the gas generating member is located in the housing in proximity to the detachable connection to enable easy replacement.

16. An operating system for a vehicle safety device according to claim 1 wherein the housing is composed of two telescoping parts, and a load limiter is connected between the two telescoping parts.

17. An operating system for a vehicle safety device according to claim 1 wherein the gas generating member is mounted in the housing and projects out of the housing.

18. An operating system for a vehicle safety device according to claim 1 wherein the housing is incorporated as part of a vehicle cross seat traverse.

19. An operating system for a vehicle safety device according to claim 1 wherein the load limiter is programmable.

20. An operating system for a vehicle safety device according to claim 1 wherein the second stage of the gas generating member generates a greater volume of gas than the first stage.

21. A method for controlling a vehicle safety device comprising the steps of
(a) providing a housing defining at least one elongated duct and a common space in said duct with a driving element having a working face received in the at least one duct for reciprocal sliding movement with its working face exposed to said common space, a thimble member mounted in the at least one elongated duct for sliding movement and axially spaced from the driving member, a cable connected at one end to actuate the vehicle safety device, extending into the at least one duct, bypassing the driving element and connected at its other end to the thimble member, and a load limiting member associated with the driving element and thimble to relieve an excess force imposed on the cable greater than the gas pressure imposed on the face of the driving element,
(b) responsive to a crash of a predetermined severity, igniting in a first stage a pyrotechnic material and generating a gas pressure in the common space of the housing to force the driving element to slide in the duct in a direction to push the thimble via the load limiter to draw the cable away from the vehicle safety device to actuate the vehicle safety device,
(c) responsive to the ignition of the first stage and with a predetermined delay automatically igniting in a second stage a pyrotechnic material to generate a further gas pressure that flows through the first stage and into the common space to maintain the pressure level in the common space at a maximal level to continue to force the driving element to continue its slide in the duct for a longer period of travel, and
(d) responsive to an excessive counter force imposed on the cable by the vehicle safety device greater than being imposed on the driving element by the gas pressure to actuate the load limiter to move the thimble closer to the driving element to relieve the excessive counter force.

22. The method of claim 21 in which the gas generated in the second stage has a greater volume than the gas generated in the first stage.
